(19) United States
(12) Patent Application Publication
(10) Pub. No.: US 2023/0124953 A1
(43) Pub. Date: Apr. 20, 2023

(54) INFORMATION PROCESSING DEVICE, INFORMATION PROCESSING METHOD, AND PROGRAM

(71) Applicant: Panasonic Holdings Corporation, Kadoma-shi, Osaka (JP)

(72) Inventors: Hideki KANEMOTO, Kanagawa (JP); Yuzo MORIUCHI, Mie (JP); Rei HASEGAWA, Osaka (JP)

(21) Appl. No.: 17/907,001

(22) PCT Filed: Mar. 18, 2021
(86) PCT No.: PCT/JP2021/011173

§ 371 Date: Sep. 22, 2022

(30) Foreign Application Priority Data
Mar. 30, 2020 (JP) 2020-060580

(51) Int. Cl. H04W 16/18; H04B 7/06; H04W 72/541

(52) U.S. Cl. CPC H04W 16/18; H04B 7/0617; H04W 72/541; H04B 7/0632

(57) ABSTRACT

Provided are an information processing device, an information processing method, and a program that enable construction of a wireless system with consideration given to interference with the surroundings of a certain area. The information processing device is provided with: an evaluation unit which evaluates interference with the outside of a specific area caused by beams that are formed at transmission points set inside the specific area and that radiate in a plurality of directions; and a determination unit which determines, on the basis of the result of the evaluation of the interference, the beam width of at least some of the beams that radiate in the plurality of directions.

### TECHNICAL FIELD

The present disclosure relates to an information processing apparatus, an information processing method, and a program.

### BACKGROUND ART

When a radio system is built in a certain area by placing a base station in the certain area, the placement of the base station is determined so that the communication quality in the certain area satisfies a desired quality.

### CITATION LIST

### Patent Literature

PTL 1

Japanese Patent Application Laid-Open No. 2018-107613

### SUMMARY OF INVENTION

For example, there is room for discussion in building a radio communication system taking into account an effect (interference) on the surroundings of the specific area.

A non-limiting example of the present disclosure facilitates providing an information processing apparatus, an information processing method, and a program that can build a radio communication system taking into account interference to the surroundings of a certain area.

An information processing apparatus according to one example of the present disclosure includes: an evaluator that evaluates interference of beams in a plurality of directions, the beams being formed in a transmission point configured inside a specific area, the interference being given to outside of the specific area; and a determiner that determines a beam width of at least one of the beams in the plurality of directions based on a result of the evaluation of the interference.

An information processing method according to one example of the present disclosure includes: evaluating, by an information processing apparatus, interference of beams in a plurality of directions, the beams being formed in a transmission point configured inside a specific area, the interference being given to outside of the specific area; and determining, by the information processing apparatus, a beam width of at least one of the beams in the plurality of directions based on a result of the evaluating of the interference.

A program according to one example of the present disclosure causes an information processing apparatus to execute processing including: evaluating interference of beams in a plurality of directions, the beams being formed in a transmission point configured inside a specific area, the interference being given to outside of the specific area; and determining a beam width of at least one of the beams in the plurality of directions based on a result of the evaluating of the interference.

It should be noted that general or specific embodiments may be implemented as a system, an apparatus, a method, an integrated circuit, a computer program, a storage medium, or any selective combination thereof.

According to an embodiment of the present disclosure, it is possible to build an appropriate radio communication system taking into account interference to the surroundings of a certain area.

Additional benefits and advantages of one embodiment of the present disclosure will become apparent from the specification and drawings. The benefits and/or advantages may be individually obtained by some embodiments and features described in the specification and drawings, which need not all be provided in order to obtain one or more of such features.

### BRIEF DESCRIPTION OF DRAWINGS

FIG. 1 is a diagram illustrating a first example of beams formed by a radio base station in a limited indoor area;

FIG. 2 is a diagram illustrating a second example of beams formed by a radio base station in a limited indoor area;

FIG. 3 is a block diagram illustrating an exemplary radio base station;

FIG. 4 is a block diagram illustrating an exemplary configuration of an information processing apparatus according to Embodiment 1;

FIG. 5A is a diagram illustrating an exemplary determination of integrated beams in Embodiment 1;

FIG. 5B is another diagram illustrating the exemplary determination of the integrated beams in Embodiment 1;

FIG. 6 is a flowchart of an exemplary processing of the information processing apparatus in Embodiment 1;

FIG. 7 is a block diagram illustrating an exemplary configuration of an information processing apparatus according to Embodiment 2;

FIG. 8A is a diagram illustrating an exemplary adjustment of a beam width in Embodiment 2;

FIG. 8B is another diagram illustrating the exemplary adjustment of a beam width in Embodiment 2;

FIG. 9 is a flowchart of an exemplary processing of the information processing apparatus in Embodiment 2;

FIG. 10 is a block diagram illustrating an exemplary configuration of an information processing apparatus according to Embodiment 3;

FIG. 11A is a diagram illustrating an exemplary adjustment of a beam width in Embodiment 3;

FIG. 11B is another diagram illustrating the exemplary adjustment of a beam width in Embodiment 3; and

FIG. 12 is a flowchart of an exemplary processing of the information processing apparatus in Embodiment 3.

### DESCRIPTION OF EMBODIMENTS

Hereinafter, preferred embodiments of the present disclosure will be described in detail with reference to the appended drawings. Note that, in the present specification and drawings, components having substantially the same functions are provided with the same reference numerals, and redundant description will be omitted.

### Embodiment 1

In a specific area (hereinafter, referred to as “limited area”), such as a factory, a shopping mall, and the like, a radio system is built by placing one or more radio base stations that cover a specific area. In this case, a radio base station with better radio communication quality in the limited area is placed.

Note that the limited area is the area spatially divided by a wall or the like. Alternatively, the limited area may correspond to a local area or the like that is owned by an individual area owner (e.g., a subjective person providing the radio service). For example, when area owners different from each other provide radio services in the area that is not spatially divided by a wall or the like, a plurality of limited areas associated with the area owners may be defined in the area. For example, when radio services are provided in an underground mall and a passage of a station that are not spatially divided and are connected with each other, the area of the underground mall and the area including the passage of the station may be defined as limited areas different from each other. Further, the limited area corresponds to an area conceptually divided with latitude, longitude, and the like.

For example, it has been discussed to use a radio system (may be referred to as “secondary use system” or “frequency sharing system”) that shares as least some of radio frequencies used by a certain radio system (may be referred to as “primary use system”) in the limited area. In this case, a radio wave radiated from a radio base station of the secondary use system may leak to the outside of the limited area. Note that, the primary use system may be a radio system already in operation (may be referred to as “existing radio system”), or may be a radio system to be built. Further, a plurality of secondary use systems may configure a primary use system and a secondary use system.

Further, for example, the utilization of a beam-forming technology using a frequency band of a millimeter wave band is considered in the secondary use system. In the beam-forming technology, a radio base station forms a beam having a directivity in a specific direction and performs fine control (hereinafter, referred to as “beam control”) of the width of the beam, the direction of the beam, the power of the beam, and the like; and thus the reception quality of a user terminal in the limited area can be enhanced and the number of multiplexing units can be increased.

However, in the conventional method for building a radio system, the main focus is to secure a radio communication quality (e.g., service quality) in the limited area, and interference to the outside of the limited area is not taken into account.

For example, when a radio system applied with a beam-forming technology is built in an indoor limited area, a radio wave leaking from the window or the like provided on the outer wall for separating the inside and outside of the limited area is the interference.

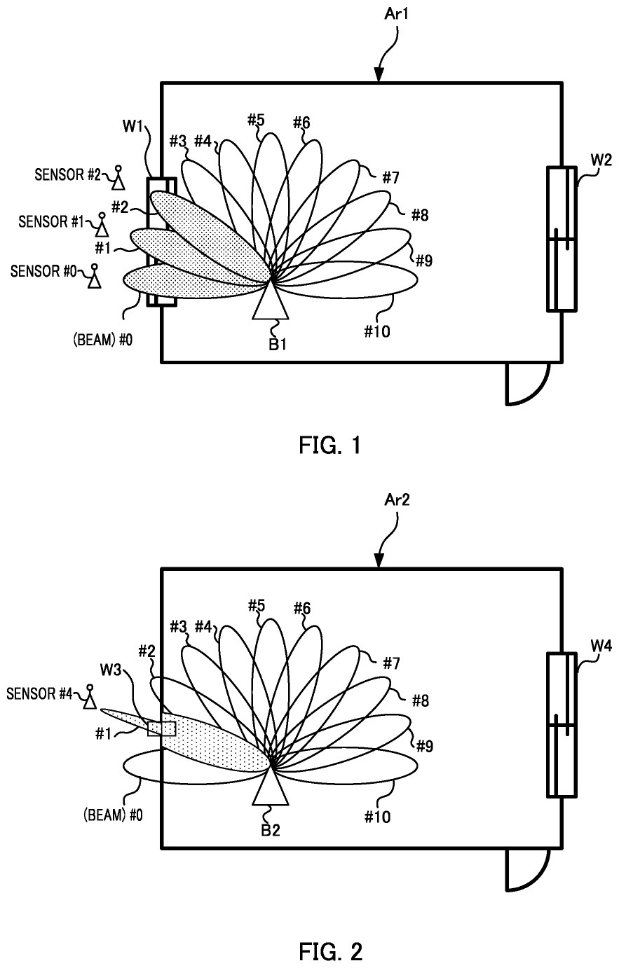

FIG. 1 is a diagram illustrating a first example of beams formed by a radio base station in an indoor limited area. FIG. 1 illustrates indoor limited area Ar1 and radio base station B1 provided in limited area Ar1 and performing beam control.

Limited area Ar1 in FIG. 1 is illustratively an indoor room. In limited area Ar1 in FIG. 1, window W1 and window W2 are provided on the wall separating the inside and outside of limited area Ar1.

Radio base station B1 illustratively forms 11 beams of beam #0 to beam #10. Beam #0 to beam #10 have directivity in different directions. Note that #0 to #10 may be referred to as identification numbers identifying the beams.

In FIG. 1, among beam #0 to beam #10, beam #0 to beam #2 leak from window W1 to the outside of limited area Ar1. For example, in case of detecting (measuring or monitoring) interference (that is, interference that interferes) given to the outside of limited area Ar1 by beam #0 to beam #2, the detection of the interference may be difficult since the beam width of each beam is narrow and the straightness of the radio wave is strong. For example, as illustrated in FIG. 1, it is possible to provide sensor #0 to sensor #2 corresponding to the respective directions of beam #0 to beam #2 outside limited area Ar1, but the cost of system building may be increased.

As illustrated in FIG. 1, when the beam-forming technology is applied to the radio system to be built, the increased number of beams corresponding to interference may cause detection and/or control of interference to be difficult.

FIG. 2 is a diagram illustrating a second example of beams formed by a radio base station in the indoor limited area. FIG. 2 illustrates indoor limited area Ar2, and radio base station B2 provided in limited area Ar2 and performing beam control.

Limited area Ar2 in FIG. 2 is illustratively an indoor room. In limited area Ar2 in FIG. 2, window W3 and window W4 are provided on the wall separating the inside and outside of limited area Ar2.

Radio base station B2 illustratively forms 11 beams of beam #0 to beam #10. Beam #0 to beam #10 have directivity in different directions.

In FIG. 2, among beam #0 to beam #10, beam #1 leaks from window W3 to the outside of limited Ar2. When window W3 is narrower than the beam width of beam #1 (the width of the beam formed at the time of transmission), the width of the radio wave (the width of the beam) leaking from window W3 to the outside of limited area Ar2 is narrower than the beam width of beam #1. For example, when the interference caused by beam #1 is detected by sensor #4 and base station B2 performs control of lowering the power of beam #1 based on the detection result, the transmission efficiency in limited area Ar2 may be reduced due to the lowering of the power.

As illustrated in FIG. 2, when the beam-forming technology is applied to the radio system to be built, the beam control for reducing interference may reduce transmission efficiency in the limited area.

A non-limiting example of the present disclosure describes the building of a radio system capable of performing beam control (e.g., control of beam width) taken into account interference to the outside of a limited area.

The following embodiments illustratively describe a case where a radio base station performing beam-forming is provided in a limited area. In this case, then, information for performing beam control taking into account interference to the outside of the limited area is determined by an information processing apparatus. For example, the information for performing beam control may include information on the number of beams, the direction, the width, the power and the like of the beam formed by the radio base station.

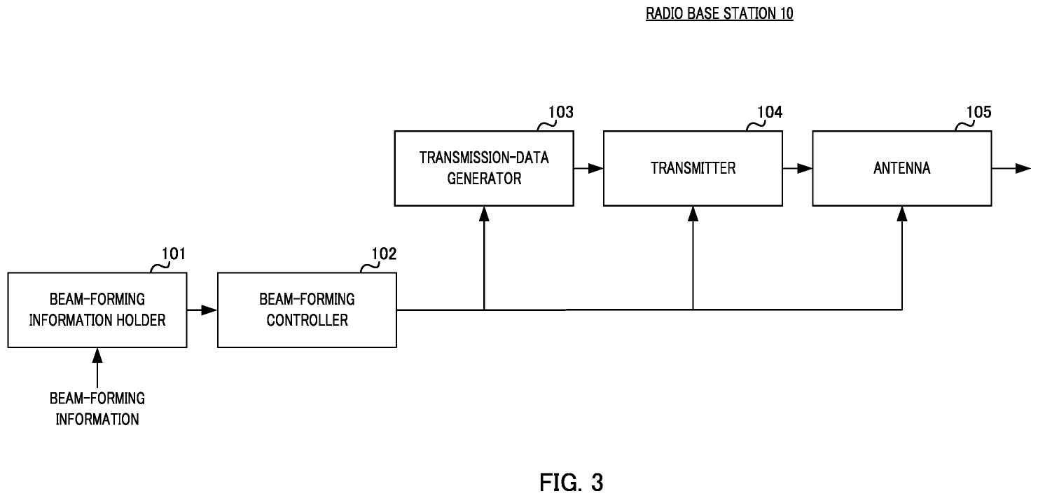

FIG. 3 is a block diagram illustrating exemplary radio base station 10. Radio base station 10 is provided in, for example, a limited area, and performs radio communication with a terminal present in the limited area. Radio base station 10 forms a beam having directivity to the direction in which the terminal is present, and transmits a signal to the terminal using the formed beam. Radio base station 10 performs beam control based on the beam-forming information determined by the information processing apparatus to be described later.

Radio base station 10 includes beam-forming information holder 101, beam-forming controller 102, transmission-data generator 103, transmitter 104, and antenna 105. Note that FIG. 3 illustrates a configuration on signal transmission by radio base station 10.

Beam-forming information holder 101 holds beam-forming information set by the information processing apparatus to be described later.

Beam-forming controller 102 controls the beam having directivity to a desired direction, for example, based on the beam-forming information held in beam-forming information holder 101. For example, the desired direction may be a direction in which the terminal is present. The direction in which the terminal is present may be determined, for example, based on the position information of the terminal, or may be determined by a signal (e.g., a control signal such as a beacon) transmitted and received between the terminal and radio base station 10.

Beam-forming controller 102 outputs information on the beam control to transmission-data generator 103, transmitter 104, and antenna 105.

Transmission-data generator 103 generates transmission data and outputs the transmission data to transmitter 104. Note that transmission-data generator 103 may weight the data to be output to transmitter 104 based on the information on the beam control. Further, transmission-data generator 103 may adjust the output timing of the data or the like when the beam control is performed in time division.

Transmitter 104 performs signal processing (e.g., encoding, modulation, or the like) on the transmission data, and generates a baseband transmission signal. Transmitter 104 performs frequency conversion processing (e.g., up-conversion) to the baseband transmission signal, generates a transmission signal of the radio frequency band (e.g., millimeter-wave band), and transmits the signal to the terminal through antenna 105. Note that transmitter 104 may perform weighting processing on the baseband transmission signal based on the information on the beam control.

Antenna 105 includes, for example, a large number of antenna elements. Antenna 105 may perform weighting processing on the transmission signal of the radio frequency band based on the information on the beam control. Antenna 105 forms a beam having directivity to a desired direction, and transmits the transmission signal of the radio frequency band.

Note that, in radio base station 10, the direction, width, and power of the beam may be adjusted by weighting based on the information on the beam control. For example, the beam width may be widened by integration of beams spatially adjacent and directed in a plurality of directions. Alternatively, one beam may be divided to reduce the width of the beams after division. Adjustment of the direction, width, and power of the beam can be achieved by the weighting control of phase and/or power in a large number of antenna elements of antenna 105. The weighting of phase and/or power can be adaptively calculated and can be achieved by being selected from some pre-calculated patterns.

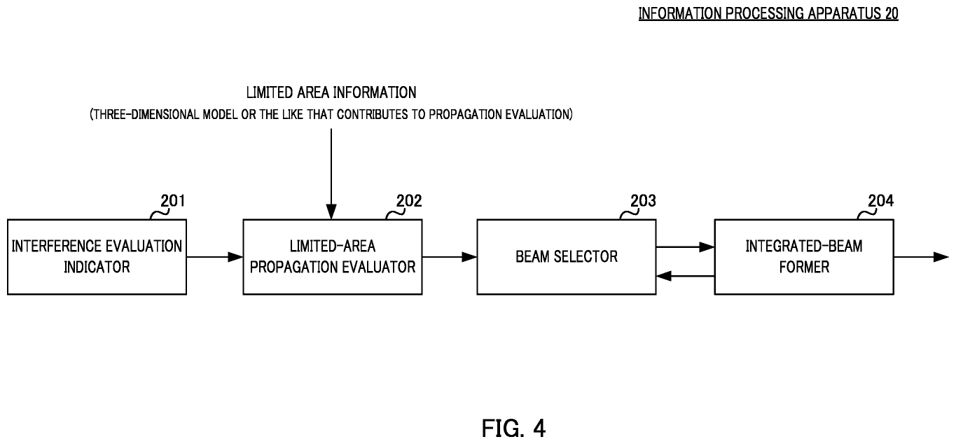

FIG. 4 is a block diagram illustrating an exemplary configuration of information processing apparatus 20 according to Embodiment 1. Information processing apparatus 20 illustrated in FIG. 4 includes interference evaluation indicator 201, limited-area propagation evaluator 202, beam selector 203, and integrated-beam former 204. Note that information processing apparatus 20 may be configured by a calculator such as a personal computer (PC), for example.

For example, interference evaluation indicator 201 and limited-area propagation evaluator 202 may be read as evaluators, and beam selector 203 and integrated-beam former 204 may be read as determiners.

Interference evaluation indicator 201 instructs limited-area propagation evaluator 202 to evaluate interference. Further, interference evaluation indicator 201 outputs a parameter of the evaluation on the interference to limited-area propagation evaluator 202. The parameter of the evaluation on the interference includes, for example, a parameter on an interference boundary provided outside the limited area. The interference boundary is a boundary on which an evaluation point of a radio wave radiating and leaking from the inside of the limited area is placed. The evaluation point is, for example, a position where a sensor for detecting interference is placed. The interference boundary may be referred to as an interference control boundary, a limited area boundary, or a site boundary. Hereinafter, information on the interference boundary may be referred to as interference boundary information.

Further, interference evaluation indicator 201 may output information on the radio base station (e.g., radio base station 10) provided in the limited area to limited-area propagation evaluator 202. The information on the radio base station may include information on a beam that the radio base station can form (e.g., the number of beams, the direction, power, and width of beams).

Limited-area propagation evaluator 202 determines a power distribution of the radio wave radiated with a predetermined power from the virtual transmission point provided in the limited area based on limited area information and interference boundary information. For example, limited-area propagation evaluator 202 may determine the power distribution by radio wave propagation simulation.

The virtual transmission point indicates, for example, a candidate position for placing the above-described radio base station 10. The limited area information is, for example, information on a two-dimensional (or three-dimensional) model that contributes to the evaluation of radio wave propagation in the limited area. The limited area information may include information of a position, number, shape, and material of a window or door provided in the limited area. Further, the limited area information may include a position, size, shape, and material of a screen (e.g., a wall partitioning the limited area, such as a partition) in the limited area.

For example, limited-area propagation evaluator 202 may determine the power distribution of the radio wave radiated by the beam formed in the virtual transmission point for each beam.

Beam selector 203 selects (specifies or identifies) a beam corresponding to the interference to the outside of the limited area based on the evaluation result (e.g., power distribution in each beam) of limited-area propagation evaluator 202. Beam selector 203 outputs information on the selected beam (e.g., an index of the selected beam) to integrated-beam former 204.

Integrated-beam former 204 determines whether to integrate the beams selected by beam selector 203. Integrated-beam former 204 integrates the selected beams when determining that the selected beams are to be integrated. Here, integrating the selected beams may correspond to, for example, replacing the selected plurality of beams with one beam incorporating a plurality of directions corresponding to the selected plurality of beams. For example, a half-value width of the replaced one beam may correspond to a half-value width of the selected plurality of beams bundled. Note that the index of evaluation of the replaced beam and the selected plurality of beams is not limited to the half-value width. For example, the index may be represented by the coverage of the beam.

Integrated-beam former 204 outputs the beam-forming information including information on the result of the formed integrated beam. The output information may be included, for example, in the beam-forming information of radio base station 10 described above. For example, the beam-forming information may include information on the integrated beam information (the identification number of the beam), the beam width, the transmission power and the like of the integrated beam.

When determining that the selected beam is not integrated, integrated-beam former 204 instructs beam selector 203 to re-select the beam. Here, the condition on the beam selection may be updated in the re-selection of the beam.

<Example of Integrated Beam>

Next, an example of the integrated beam in information processing apparatus 20 will be described.

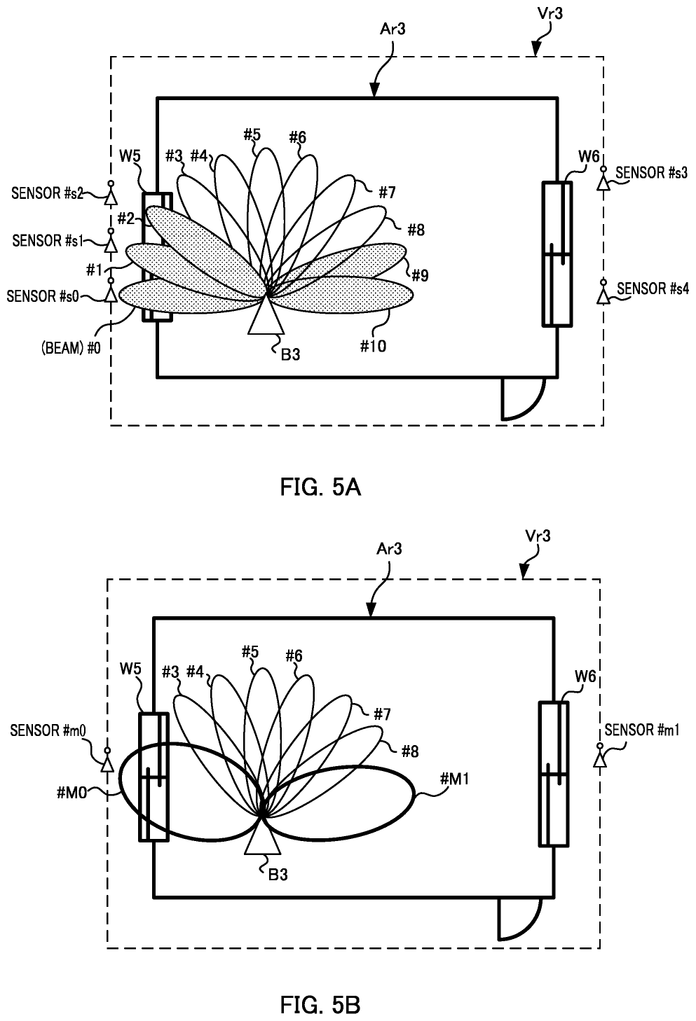

FIGS. 5A and 5B are diagrams illustrating exemplary determination of integrated beams in Embodiment 1. FIGS. 5A and 5B each illustrate radio base station B3 provided in limited area Ar3 and performing beam control. Note that FIG. 5A illustrates an example of beams before determination of the integrated beams, and FIG. 5B illustrates an example of beams after determination of the integrated beams.

Limited area Ar3 is illustratively an indoor room. In each limited area Ar3 of FIGS. 5A and 5B, windows W5 and W6 are provided on the walls separating the inside and outside of limited area Ar3. Further, FIGS. 5A and 5B illustrates interference boundary Vr3. Interference boundary Vr3 is set by information processing apparatus 20, for example. Alternatively, interference boundary Vr3 may be specified along with an interference level from a frequency sharing system. The frequency sharing system may specify the interference level and may not specify interference boundary Vr3.

Note that, when the interference boundary is not specified, the interference boundary may be an outer periphery of the limited area. Alternatively, when the limited area is an indoor area and the interference boundary is not specified, the interference boundary may be an outer periphery of the site.

FIG. 5A illustrates exemplary beams formed by radio base station B3 before determination of the integrated beams. Radio base station B3 in FIG. 5A illustratively forms 11 beams of beam #0 to beam #10. Beam #0 to beam #10 have directivity in different directions. Note that #0 to #10 may be referred to as identification numbers identifying the beams. For example, two adjacent beams may be numbered with two consecutive identification numbers.

In FIG. 5A, among beam #0 to beam 10, beam #0 to beam #2 correspond to radio waves leaking from window W5 to the outside of limited area Ar3, and beam #9 and beam #10 correspond to radio waves leaking from window W6 to the outside of limited area Ar3. In FIG. 5A, sensor #s0 to #s4 are assumed to be provided to detect beams #0 to beam #2, beam #9 and beam #10, and the interference by the beams, respectively.

Information processing apparatus 20 measures or evaluates, for example, the power of interference leaking to the outside of the limited area for each beam. This evaluation may be performed, for example, by radio propagation simulation.

For example, in FIG. 5A, that beam #0 to beam #2 indicate interference equal to or higher than an interference level. In this case, since beam #0 to beam #2 are adjacent to each other, information processing apparatus 20 may determine to integrate these three beams.

Further, for example, in FIG. 5A, beam #9 and beam #10 indicate interference equal to or higher than the interference level. In this case, since beam #9 and beam #10 are adjacent to each other, information processing apparatus 20 may determine to integrate these two beams.

FIG. 5B illustrates exemplary beams formed by radio base station B3 after determination of the integrated beams. FIG. 5B illustrates an example of beam #M0 integrating beam #0 to beam #2 illustrated in FIG. 5A and beam #M1 integrating beam #9 and beam #10.

For example, the half-value width of beam #M0 may correspond to the half-value width of beam #0 to beam #2 bundled. Further, the half-value width of beam #M1 may correspond to the half-value width of beam #9 and beam #10 bundled.

Beam #0 to beam #2 are substituted for beam #M0, and thus, as illustrated in FIG. 5B, the interference given to the outside of limited area Ar3 by beam #M0 can be detected by one sensor (sensor #m0). Further, beam #9 and beam #10 are substituted for beam #M1, and thus, as illustrated in FIG. 5B, the interference given to the outside of limited are Ar3 by beam #M1 can be detected by one sensor (sensor #m1). As indicated by comparison of FIGS. 5A and 5B, the number of sensors detecting interference can be reduced by integration of the beams.

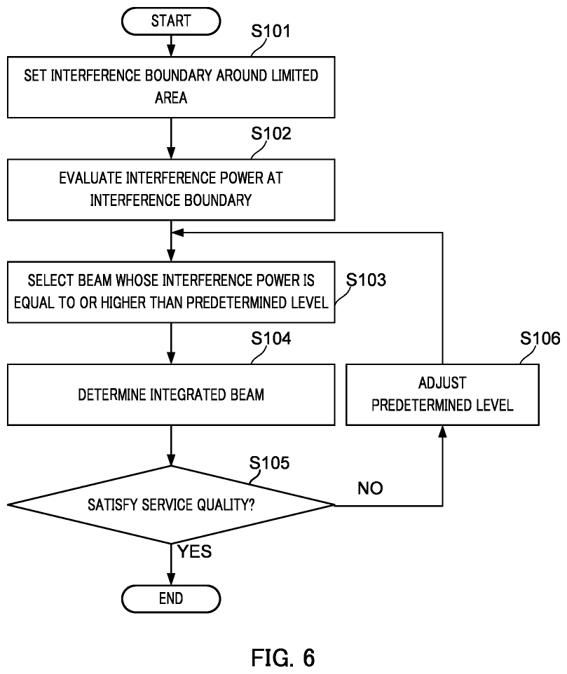

Next, a processing flow of information processing apparatus 20 according to Embodiment 1 will be described. FIG. 6 is a flowchart illustrating an exemplary processing of information processing apparatus 20 according to Embodiment 1.

The flowchart illustrated in FIG. 6 is started, for example, based on an instruction by an administrator (user) who builds a frequency sharing system in the limited area. For example, the administrator may provide an instruction to start the determination of information on beam control of base station 10 through the operator that information processing apparatus 10 includes. The instruction input to information processing apparatus 20 through the operator is given to, for example, interference evaluation indicator 201. Note that, in this case, the administrator may input information such as limited area information.

Interference evaluation indicator 201 sets an interference boundary around the limited area (S101).

Limited-area propagation evaluator 202 evaluates the interference power at the interference boundary (S102).

Beam selector 203 selects a beam whose interference is equal to or higher than a predetermined level (e.g., an interference level) (S103).

Integrated-beam former 204 determines the integrated beam from the selected beams (S104).

After the integrated beam is determined, integrated-beam former 204 determines whether the service quality in the limited area satisfies a predetermined quality (S105). For example, this determination may be performed based on whether the value (e.g., throughput) representing the service quality assumed based on the determined power distribution determined from the integrated power distribution by radio propagation simulation is equal to or higher than a predetermined value.

When the service quality does not satisfy the predetermined quality (NO in S105), integrated-beam former 204 adjusts the predetermined level (S106). For example, integrated-beam former 204 may lower or increase the predetermined level. Then, the process of S103 is executed.

When the service quality satisfies the predetermined quality (YES in S105), integrated-beam former 204 generates beam-forming information including information on the formed integrated beam, and the flow illustrated in FIG. 6 ends.

As described above, in Embodiment 1, integration of a plurality of beams serving as interference allows easier detection and control of interference and allows to build a radio system taking into account interference. For example, integration of a plurality of beams serving as interference can reduce the number of sensors provided outside the limited area to detect interference compared to the case where a plurality of beams are not integrated. Further, reducing power of the integrated beam allows reducing interference efficiently and easier control of interference.

Note that adjustment of the predetermined level for determining the subject for integration of beams allows adjustment of the trade-off between increase/decrease of the number of terminals accommodated (number of multiplexing units) when the beams are integrated and ease of detection and control of interference. This adjustment may be executed depending on a structure of the limited area, and/or a service quality desired in the limited area.

For example, adjustment of the predetermined level to reducing the number of subjects for integration of beams (e.g., increasing a predetermined level) can increase the number of terminals being accommodated. On the other hand, adjustment of the predetermined level to increasing the number of subject for integration of beams (e.g., decreasing a predetermined level) can increase the number of integrated beams and allows easier detection and control of interference.

For example, when the service quality desired in the limited area is relatively low (e.g., the number of terminals to be accommodated may be relatively small), an adjustment that makes the detection and control of interference easier may be executed.

In the above-described example, the subject for integration of beams is determined based on whether interference is equal to or higher than the predetermined level or not, but the present disclosure is not limited thereto. For example, the subject for integration of beams may be determined based on whether a certain beam corresponds to a line-of-sight environment. When the direction of the certain beam is a line-of-sight environment with respect to the interference boundary, in other words, when there is no obstacle that causes reflection, refraction, attenuation, or the like of a radio wave in the direction of the beam until the certain beam reaches the interference boundary, the certain beam may be determined to be the subject for integration.

### Embodiment 2

In Embodiment 2, an example of facilitating detection and control of interference by an adjustment of a beam width will be described.

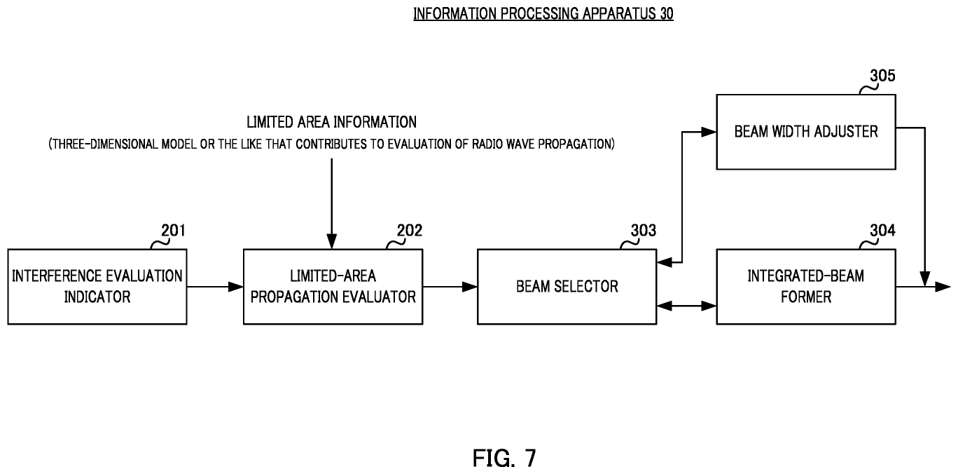

FIG. 7 is a block diagram illustrating an exemplary configuration of information processing apparatus 30 according to Embodiment 2. Note that, in FIG. 7, the same components as those in FIG. 4 are denoted by the same reference numerals, and a description thereof may be omitted.

For example, in FIG. 7, interference evaluation indicator 201 and limited-area propagation evaluator 202 may be read as evaluators, and beam selector 303, integrated-beam former 304, and beam width adjuster 305 may be read as determiners.

Beam selector 303 selects a beam corresponding to the interference to the outside of the limited area based on the evaluation result (e.g., power distribution for each beam) of limited-area propagation evaluator 202. Beam selector 303 outputs information on the selected beam (e.g., an index of the selected beam) to integrated-beam former 304 and beam width adjuster 305.

Integrated-beam former 304 determines whether to integrate the beams selected by beam selector 303. When it is determined that the selected beams are to be integrated, integrated-beam former 304 integrates the selected beams in the same manner as integrated-beam former 204 illustrated in FIG. 4.

Beam width adjuster 305 adjusts at least one beam width of the selected beams when the beams selected by beam selector 303 are not spatially adjacent to each other. For example, beam width adjuster 305 adjusts the beam width to a direction to widen the beam width.

Beam width adjuster 305 outputs beam-forming information including information of the beam width after the adjustment when the beam of the adjusted beam width satisfies a predetermined condition. The beam-forming information may include information on the beam to be adjusted (e.g., an identification number) and information on the beam width after the adjustment and the transmission power.

<Example of Beam Width Adjustment>

Next, an example of an adjustment of a beam width (widening of the beam width) in information processing apparatus 30 will be described.

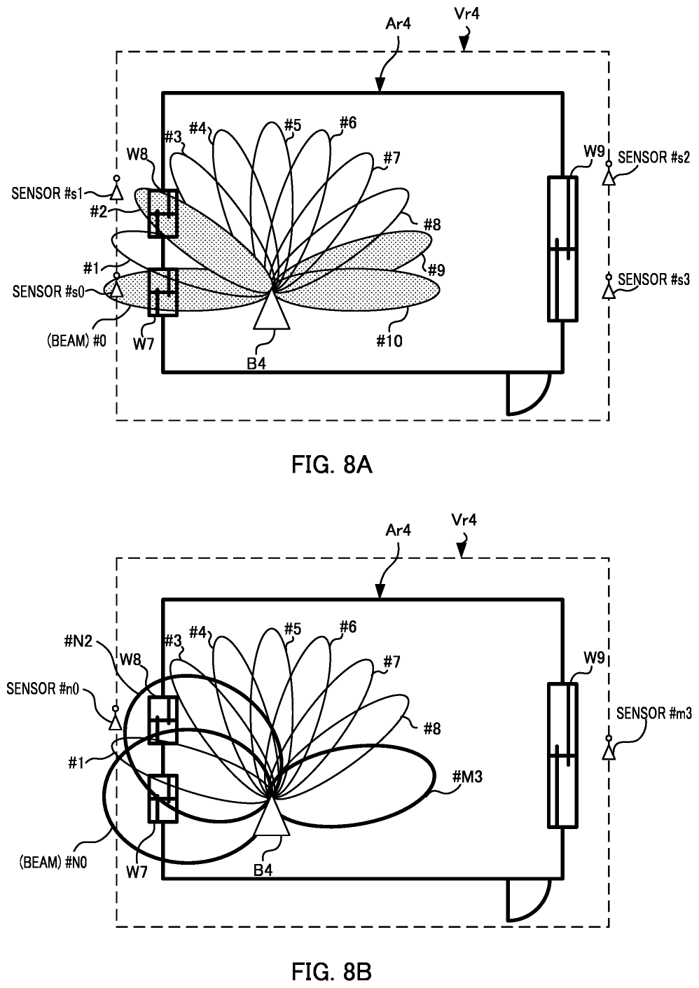

FIGS. 8A and 8B are diagrams illustrating an exemplary adjustment of a beam width in Embodiment 2. FIGS. 8A and 8B each illustrate radio base station B4 provided in limited area Ar4 and performing beam control. Note that FIG. 8A illustrates an example of the beams before the beam width is adjusted, and FIG. 8B illustrates an example of the beams after the beam width is adjusted. Note that the adjustment of the beam width in FIGS. 8A and 8B includes determination of the integrated beam described in Embodiment 1.

Limited area Ar4 is illustratively an indoor room. In each limited area Ar4 of FIGS. 8A and 8B, windows W7, W8, and W9 are provided on the walls separating the inside and outside of limited area Ar4. Also, FIGS. 8A and 8B each illustrate interference boundary Vr4 in the same manner as FIGS. 5A and 5B.

FIG. 8A illustrates exemplary beams formed by radio base station B4 before the beam width is adjusted. Radio base station B2 in FIG. 8A illustratively forms 11 beams of beam #0 to beam #10. Beam #0 to beam #10 have directivity in different directions.

In FIG. 8A, among beam #0 to beam 10, beam #0 corresponds to a radio wave leaking from window W7 to the outside of limited area Ar4, and beam #2 corresponds to a radio wave leaking from window W8 to the outside of limited area Ar4. Further, beam #9 and beam #10 correspond to radio waves leaking from window W9 to the outside of limited area Ar4. In FIG. 8A, sensors #s0 to #s3 are assumed to be provided to detect beam #0, beam #2, beam #9, and beam #10 and the interference by the beams, respectively.

Information processing apparatus 30 measures or evaluates, for example, the power of interference leaking to the outside of the limited area in each beam. This evaluation may be performed, for example, by radio propagation simulation.

For example, FIG. 8A indicates that beam #9 and beam #10 are interference equal to or higher than a interference level. In this case, similarly to Embodiment 1, since beam #9 and beam #10 are adjacent to each other, information processing apparatus 30 may determine to integrate these two beams.

Further, for example, FIG. 8A indicates that beam #0 and beam #2 are interference equal to or higher than the interference level. In this case, since beam #0 and beam #2 are not adjacent to each other, information processing apparatus 30 may determine not to integrate these two beams. Then information processing apparatus 30 determines to widen at least one beam width of beam #0 and beam #2. Then, information processing apparatus 30 determines a beam width that is a beam width of at least one of beam #0 and beam #2 is widened.

FIG. 8B illustrates exemplary beams formed by radio base station B2 after the beam width is adjusted. FIG. 8B illustrates an example of beam #M3 integrating beam #9 and beam #10, beam #NO widening the beam width of beam #0, and beam #N2 widening the beam width of beam #2.

The width in the case of widening the beam width is not particularly limited, but the beam width may be gradually widened and may be determined to be a beam width satisfying a predetermined condition as a beam width after being widened, for example. For example, the beam width satisfying the predetermined condition may be a beam width capable of reducing the number of sensors provided on interference boundary Vr4, a beam width satisfying a predetermined service quality in limited area Ar4, or a combination thereof.

For example, in FIG. 8B, interference that beam #NO gives to the outside of limited area Ar4 and interference that beam #N1 gives to the outside of limited area Ar4 are detected by the same sensor #n0. In this manner, the beam widths of beam #NO and beam #N1 may be determined so that the number of sensors can be reduced.

Further, similarly to Embodiment 1, beam #9 and beam #10 are replaced with beam #M3, and thus interference that beam #M3 gives to the outside of limited area Ar4 can be detected by one sensor (sensor #m3) as illustrated in FIG. 8B.

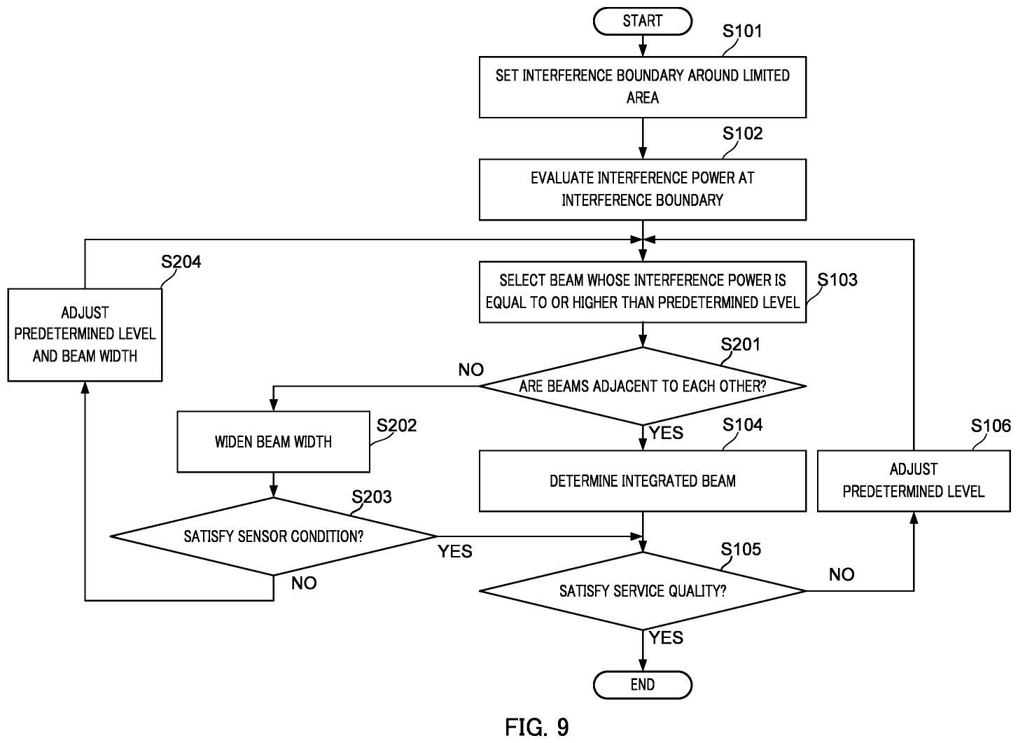

Next, a processing flow of information processing apparatus 30 according to Embodiment 2 will be described. FIG. 9 is a flowchart of an exemplary processing of information processing apparatus 30 in Embodiment 2. In FIG. 9, the same processes as those in FIG. 6 are denoted by the same reference numerals, and a description thereof may be omitted.

The flowchart illustrated in FIG. 9 is started, for example, based on an instruction by an administrator (user) who builds a frequency sharing system in the limited area. For example, the administrator may instruct to start the determination of information on beam control of base station 10 through the operator of information processing apparatus 30. The instruction input to information processing apparatus 30 through the operator is given to, for example, interference evaluation indicator 201. Note that, in this case, the administrator may input information such as limited area information.

Beam selector 303 determines whether the selected beams are beams adjacent to each other (S201).

When the selected beams are beams adjacent to each other (YES in S201), the process of S104 is executed.

When the selected beams are not beams adjacent to each other (NO in S201), the beam width adjuster 305 widens at least one beam width of the selected beams (S202).

Beam width adjuster 305 determines whether the beam whose beam width is widened satisfies a sensor condition (S203). The sensor condition may correspond, for example, to being capable of detecting interference by a plurality of beams by one sensor (or sensors whose number is smaller than the number of beams). In other words, in S203, it may be determined whether the number of sensors detecting interference by the beam whose beam width is widened is smaller than the number of sensors detecting interference by the beam before the beam width is widened. Further, in S203, it may be determined whether the widening of the beam width reduces the number of sensors detecting interference.

When the beam whose beam width is widened satisfies the sensor condition (YES in S203), for example, when the widening of the beam width reduces the number of sensors detecting interference, the process of S105 is executed.

When the beam whose beam width is widened does not satisfy the sensor condition (NO in S203), for example, when the widening of the beam width cannot reduce the number of sensors detecting interference, beam width adjuster 305 adjusts the predetermined level and the beam width (S204). For example, in the adjustment of the beam width in S204, the beam width widened in S202 is returned to the beam width before the adjustment. Further, in the adjustment of the predetermined level in S204, the predetermined level may be lowered or increased. Then, the process of S103 is executed.

As described above, control (e.g., control to widen) of a beam width serving as interference allows easier detection and control of interference and allows to build a radio system taking into account interference in Embodiment 2. For example, widening width of the beam serving as interference can reduce the number of sensors provided outside the limited area to detect interference compared to the case where the width of the beam is not widened. Further, interference can be reduced efficiently by lowering the power of the beam, and thus the control of interference can be facilitated.

### Embodiment 3

In Embodiment 3, an example in which the interference to the outside of the limitation area is reduced by an adjustment of a beam width to suppress reduction of transmission efficiency in the limited area will be described.

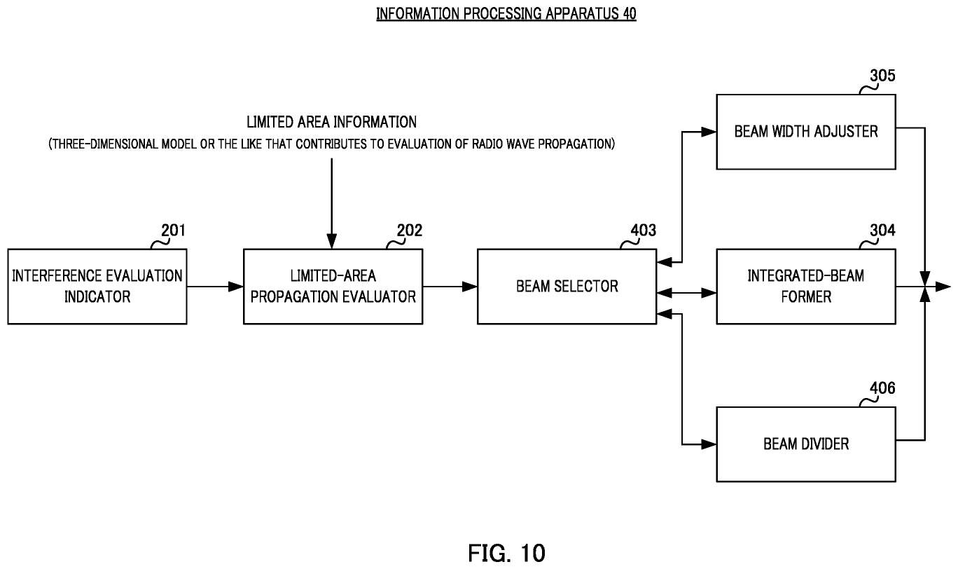

FIG. 10 is a block diagram illustrating an exemplary configuration of information processing apparatus 40 according to Embodiment 3. In FIG. 10, the same components as those in FIG. 4 are denoted by the same reference numerals, and a description thereof is omitted.

For example, in FIG. 10, interference evaluation indicator 201 and limited-area propagation evaluator 202 may be read as evaluators, and beam selector 403, integrated-beam former 304, beam width adjuster 305, and beam divider 406 may be read as determiners.

Beam selector 403 selects the beam corresponding to interference to the outside of the limitation area based on the evaluation result (e.g., power distribution in each beam) of limited-area propagation evaluator 202. Beam selector 403 outputs information (e.g., an index of the selected beam) on the selected beam to integrated-beam former 304, beam width adjuster 305, and beam divider 406.

Beam divider 406 determines whether to divide the selected beam, and when dividing, divides the selected beam into a plurality of beams whose beam width is narrower. Beam divider 406 outputs beam-forming information including information on the divided beam width when the beam with the beam width after division satisfies a predetermined condition. For example, beam divider 406 may determine that the selected beam is to be divided when the width of a signal corresponding to a beam serving as interference is narrow compared to the beam width of a beam formed in radio base station 10 (virtual transmission point). For example, beam divider 406 may divide the beam when the leak gap (e.g., the size of the window) is narrower than the transmission beam. The width of the beam serving as interference is limited by the division of the beam.

<Example of Beam Width Adjustment>

Next, an example of adjustment of the beam width (reduction of the beam width) in information processing apparatus 40 will be described. The following describes an example of dividing one beam to reduce the beam width of each divided beam. Note that, in the present disclosure, the beam width of a certain beam may be reduced without the beam being divided.

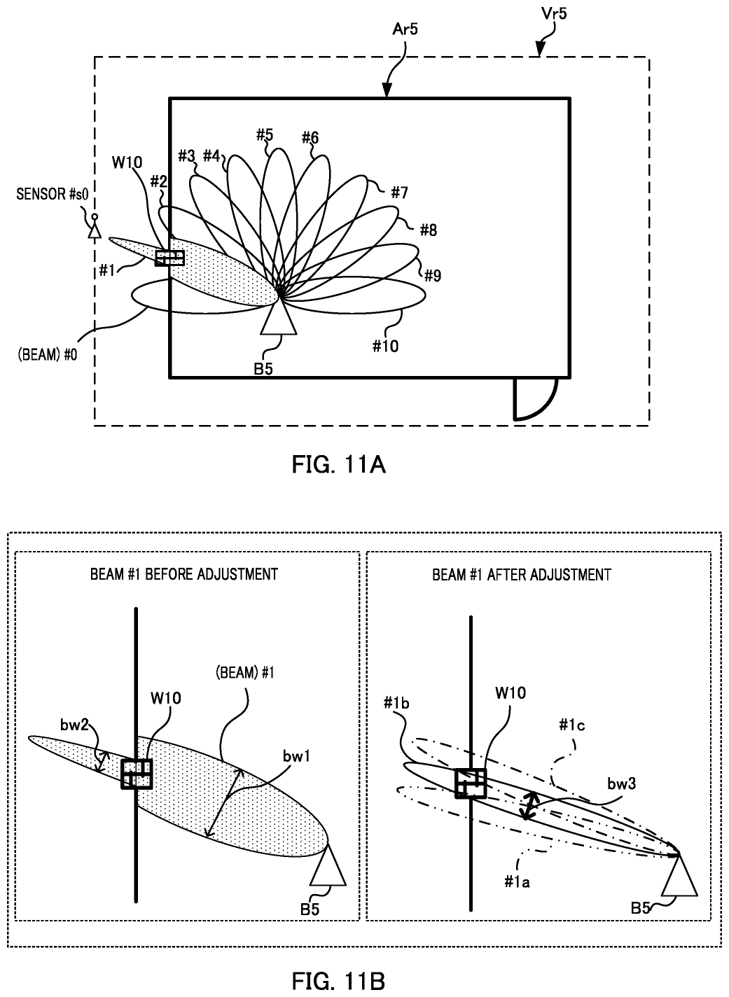

FIGS. 11A and 11B are diagrams illustrating an example of a beam width adjustment in Embodiment 3. FIGS. 11A and 11B each illustrate radio base station B5 provided in limited area Ar5 and performing beam control.

Limited area Ar5 is illustratively an indoor room. In each limited area Ar5 in FIGS. 11A and 11B, windows W10 is provided on the wall separating the inside and outside of limited area Ar5. Also, FIGS. 11A and 11B each illustrate interference boundary Vr5, similarly to the example illustrated in FIGS. 5A and 5B.

FIG. 11A illustrates an exemplary beam formed by radio base station B5 before the beam width is adjusted. Radio base station B2 in FIG. 8A illustratively forms 11 beams of beam #0 to beam #10. Beam #0 to beam #10 have directivity in different directions.

In FIG. 11A, among beam #0 to beam 10, beam #1 leaks from window W10 to the outside of limited area Ar5. In FIG. 11A, window W10 is narrow compared to the beam width of beam #1, and thus the width (beam width) of the radio wave leaking to the outside of limited area Ar5 from window W10 is narrow compared to the beam width of beam #1 (the width of the beam formed at the time of transmission).

Information processing apparatus 40 measures or evaluates the power of interference leaking to the outside of the limited area in each beam, for example. For example, information processing apparatus 40 may evaluate a heat map of the power, and may compare the width of the part corresponding to interference (e.g., the width of the beam leaking from window W10) and the width of the beam formed at the time of transmission in the heat map. Then, information processing apparatus 40 may determine the beam for the adjustment of the beam width and adjust the beam width of the determined beam. This evaluation may be performed, for example, by radio propagation simulation.

For example, FIG. 11A indicates that beam #1 is interference equal to or higher than an interference level. Then, since the width of beam #1 leaking from window W10 is narrower than the width of beam #1 formed at the time of transmission, it is determined that beam #1 is the beam for the adjustment of the beam width. In this case, information processing apparatus 40 determines to reduce the beam width of beam #1. For example, by dividing beam #1, information processing apparatus 40 may reduce the beam width of the beam after division more than the beam width of the beam before division.

FIG. 11B illustrates beam #1 before the adjustment illustrated in FIG. 11A and beam #1 after the adjustment. As illustrated in FIG. 11B, width bw1 of beam #1 formed at the time of transmission is wider than width bw2 of the part corresponding to interference (e.g., width bw2 of the beam leaking from window W10) in beam #1 before the adjustment. In beam #1 after the adjustment, beam #1 is divided into beam #1a (corresponding to the beam of the two-dot chain line), beam #1b (corresponding to the beam of the solid line), and beam #1c (corresponding to the beam of the one-dot chain line). In FIG. 11B, width bw3 of beam #1b is adjusted to be narrower than width bw1. For example, width bw3 of beam #1b may be narrower than width bw2. Note that width bw2 in FIG. 11B may correspond to the width of interference. Width bw2 may also correspond to the width of the boundary of limited area Ar5 corresponding to interference (window W10 in the examples of FIGS. 11A and 11B).

The width in case of reducing the beam width is not particularly limited, but the beam width is gradually reduced, and the beam width that satisfies a predetermined condition may be determined as the beam width after reduction. For example, the beam width that satisfies a predetermined condition may be a beam width equal to or narrower than the width of the beam corresponding to interference, a beam width in which the service quality in limited area Ar5 satisfies a predetermined quality, or a combination thereof.

For example, in FIG. 11B, while it is likely that beam #1b gives interference to the outside of limited area Ar5, it is unlikely that beam #1a and beam #1c give interference to the outside of limited area Ar5. Here, the interference to the outside of limited area Ar5 can be reduced by the reduction of transmission power of beam #1b. Further, interference can be reduced without reducing the transmission power of beam #1a and beam #1c, and thus the reduction of the service quality (e.g., transmission efficiency) in limited area Ar5 can be suppressed.

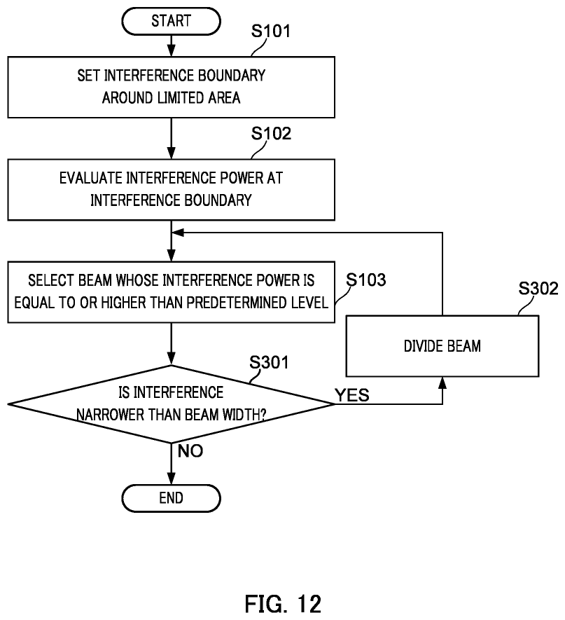

Next, a processing flow of information processing apparatus 40 according to Embodiment 3 will be described. FIG. 12 is a flowchart of an example of a processing of information processing apparatus 40 in Embodiment 3. Note that, in FIG. 12, the same processes as those in FIG. 6 are denoted by the same reference numerals, and a description thereof may be omitted.

The flowchart illustrated in FIG. 12 is started, for example, based on an instruction by an administrator (user) who builds a frequency sharing system in the limited area. For example, the administrator may instruct to start the determination of information on beam control of base station 10 through the operator of information processing apparatus 40. The instruction input to information processing apparatus 40 through the operator is given to, for example, interference evaluation indicator 201. Note that, in this case, the administrator may input information such as limited area information.

Beam selector 403 determines whether the beam width corresponding to interference in the selected beam is narrower than the beam width of the beam formed at the time of transmission (S301).

When the beam width corresponding to interference is not narrower than the beam width of the beam formed at the time of transmission (NO in S301), the flow illustrated in FIG. 12 ends.

When the beam width corresponding to interference is narrower than the beam width of the beam formed at the time of transmission (YES in S301), beam divider 406 reduces the beam width by dividing the selected beam (S302). Then, the process of S103 is performed.

Note that the flowchart illustrated in FIG. 12 illustrates the processing flow relating to the adjustment for reducing the beam width, and the adjustment for widening the beam width is omitted. The adjustment for widening the beam width is illustrated in FIG. 9. The flowchart illustrated in FIG. 12 may be combined with the flowchart in FIG. 9. For example, the processing illustrated in FIG. 12 ends, and the process of S201 of the flowchart in FIG. 9 may be performed.

As described above, controlling the width of the beam serving as interference allows easier control of interference, and allows to build a radio system taking into account interference in Embodiment 3. For example, dividing the beam serving as interference reduces the power of the divided beam corresponding to the part leaking to the outside of the limited area, and maintaining the power of the divided beam that does not correspond to the part leaking to the outside of the limited area reduces interference to the outside of the limited area and suppresses the reduction of transmission efficiency in the limited area.

Note that in each of the above embodiments, a case of taking into account interference that a secondary use system that shares a frequency band with a primary use system gives to the primary use system has been described, but the present disclosure is not limited thereto. For example, the present disclosure may be applied to a case where interference between a plurality of secondary use systems sharing a frequency band is taken into account. In this case, the placement of the radio base station may be determined in the same manner as those in the above embodiments in each of the plurality of secondary use systems.

Note that, in the above described embodiments, control of the beam formed in a planner manner (two-dimensionally) has been exemplified, but the present disclosure is not limited thereto. For example, beams that are spatially (three-dimensionally) formed may be controlled. In this case also, as described in each of the above embodiments, the information processing apparatus determines the beam width of at least some beams based on the evaluation result of interference. This allows radio base station to perform beam control based on the beam-forming information including the beam width determined by the information processing apparatus, and thus detection and control of interference can be easily performed and a radio system taking into account interference cane be built.

Note that the information processing apparatus according to each of the above-described embodiments may be configured as a computer apparatus including a processor, a memory, a storage, a communication device, an input device, an output device, a bus, and the like.

Note the term “integrate” used in the above-described embodiments may be replaced with another term such as “summarize”, “synthesize”, and “combine”.

In the above-described embodiments, the term “-er/-or” used for the name of a component may be replaced with another term such as “circuitry”, “device”, “unit”, or “module”.

In addition, the expression “frequency band” in the embodiment described above may be replaced by other expressions such as “frequency”, “frequency channel”, “band”, “carrier”, “sub-carrier”, or “(frequency) resource”.

The present disclosure can be realized by software, hardware, or software in cooperation with hardware.

Each functional block used in the description of each embodiment described above can be partly or entirely realized by an LSI such as an integrated circuit, and each process described in the embodiments may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration.

The technique of implementing an integrated circuit is not limited to the LSI and may be realized by using a dedicated circuit, a general-purpose processor, or a special-purpose processor. In addition, a Field Programmable Gate Array (FPGA) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. Some non-limiting examples of such a communication apparatus include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may include a device such as a controller or a sensor which is coupled to a communication device performing a function of communication described in the present disclosure. For example, the communication apparatus may include a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

Various embodiments have been described with reference to the drawings hereinabove. Obviously, the present disclosure is not limited to these examples. Obviously, a person skilled in the art would arrive variations and modifications within a scope described in claims, and it is understood that these variations and modifications are within the technical scope of the present disclosure. Each constituent element of the above-mentioned embodiments may be combined optionally without departing from the spirit of the disclosure.

Specific examples of the present disclosure have been described thus far, but these examples are only exemplary, and are not to limit the claims. Techniques recited in the claims include, for example, variations and/or modifications of the specific examples exemplified above.

The disclosure of Japanese Patent Application No. 2020-060580, filed on Mar. 30, 2020, including the specification, drawings and abstract, is incorporated herein by reference in its entirety.

### INDUSTRIAL APPLICABILITY

The present disclosure is suitable for a wireless communication system.

### REFERENCE SIGNS LIST

10 Radio base station
20, 30, 40 Information processing apparatus
101 Beam-forming information holder
102 Beam-forming controller
103 Transmission-data generator
104 Transmitter
105 Antenna
201 Interference evaluation indicator
202 Limited-area propagation evaluator
203, 303, 403 Beam selector
204, 304 Integrated-beam former
305 Beam width adjuster
406 Beam divider

1. An information processing apparatus comprising:
an evaluator that evaluates interference of beams in a plurality of directions, the beams being formed in a transmission point configured inside a specific area, the interference being given to outside of the specific area; and
a determiner that determines a beam width of at least one of the beams in the plurality of directions based on a result of the evaluation of the interference.

2. The information processing apparatus according to claim 1, wherein
the determiner determines a beam width of a beam resulting from integration of the at least one of the beams corresponding to the interference equal to or higher than a predetermined level.

3. The information processing apparatus according to claim 2, wherein
the determiner evaluates a quality in the specific area based on the determined beam width, and
the determiner adjusts the predetermined level and re-determines the beam width, when the quality does not satisfy a predetermined quality.

4. The information processing apparatus according to claim 1, wherein
the determiner widens a beam width of at least one of the beams in at least one of the plurality of directions, when the beams in the at least one of the plurality of directions and corresponding to the interference equal to or higher than a predetermined level are not adjacent to each other.

5. The information processing apparatus according to claim 4, wherein
the determiner judges whether the beam widened in the beam width is detected by a sensor provided outside the specific area, and
the determiner adjusts the predetermined level and re-determines the beam width, when the beam widened in the beam width is not detected by the sensor.

6. The information processing apparatus according to claim 1, wherein
the determiner determines, when a first width of the beam in the at least one of the plurality of directions and corresponding to the interference is wider than a width of the interference, the beam width of the beam in the at least one of the plurality of directions to be a second width narrower than the first width.

7. The information processing apparatus according to claim 6, wherein
the determiner divides a beam width of the beam in the at least one of the plurality of directions.

8. An information processing method comprising:
evaluating, by an information processing apparatus, interference of beams in a plurality of directions, the beams being formed in a transmission point configured inside a specific area, the interference being given to outside of the specific area; and
determining, by the information processing apparatus, a beam width of at least one of the beams in the plurality of directions based on a result of the evaluating of the interference.

9. A program that causes an information processing apparatus to execute processing comprising:
evaluating interference of beams in a plurality of directions, the beams being formed in a transmission point configured inside a specific area, the interference being given to outside of the specific area; and
determining a beam width of at least one of the beams in the plurality of directions based on a result of the evaluating of the interference.
